(19) United States
(12) Patent Application Publication
(10) Pub. No.: US 2008/0263441 A1
(43) Pub. Date: Oct. 23, 2008

(54) WEBPAGE BOOKMARKING METHOD FOR MOBILE TERMINAL

(76) Inventors: Sang Min PARK, Seoul (KR); Tae Seop HAN, Gumi-si (KR); Chang Taek KANG, Gumi-si (KR)

Correspondence Address: CHA & REITER, LLC, 210 ROUTE 4 EAST STE 103, PARAMUS, NJ, 07652, US

(21) Appl. No.: 11/934,948

(22) Filed: Nov. 5, 2007

(30) Foreign Application Priority Data
Apr. 18, 2007 (KR) 2007-0037683

(51) Int. Cl. G06F 17/00; G06F 3/02

(52) U.S. Cl. 715/241; 345/172

(57) ABSTRACT

A webpage bookmarking method for a mobile terminal is disclosed. The webpage bookmarking method includes the steps of checking, during webpage display, whether a division bookmark setting request is issued and setting a division bookmark at a specified section of a webpage being displayed. As a result, a bookmark can be set at a desired section of a webpage, and the user can easily make a jump to the bookmarked section during browsing of a large webpage.

### CLAIM OF PRIORITY

This application claims the benefit of the earlier filing date, pursuant to 35 USC 119, to that patent application entitled “WEBPAGE BOOKMARKING METHOD FOR MOBILE TERMINAL,” filed in the Korean Intellectual Property Office on Apr. 18, 2007 and assigned Serial No. 2007-0037683, the contents of which are incorporated herein by reference.

### BACKGROUND OF THE INVENTION

1. Field of the Invention

The present invention relates to mobile devices, and, more particularly, to a webpage bookmarking method for a mobile terminal that enables placement of a bookmark at a selected section of a webpage.

2. Description of the Related Art

Wireless data services through mobile terminals enable wireless transmission and reception of information including characters, numbers, and graphics. Using such a wireless data service, a user of a mobile terminal in motion can receive information regarding, for example, traffic conditions and stock prices. In particular, a wireless Internet service enables the user to navigate webpages on the Internet using a web browser installed in the mobile terminal. An advanced mobile terminal can provide various supplementary services comparable to those provided by a personal computer having a wired connection to the Internet.

To facilitate web surfing, a mobile terminal provides a bookmarking function, which enables the user to set a bookmark at a frequently visited webpage and to jump to the bookmarked webpage at later times without entering an address. A bookmark is a link to a particular webpage, and includes a uniform resource locator (URL) of the webpage and a short description on the webpage such as a page name.

However, using a conventional bookmarking function of a mobile terminal, the user may be not able to directly view a desired section or division of a bookmarked webpage. This is because the screen size of the mobile terminal is much less than that of a webpage. To view the desired section of the bookmarked webpage, the user may have to enter a number of commands after a jump to the bookmarked webpage.

### SUMMARY OF THE INVENTION

The present invention provides a webpage bookmarking method for a mobile terminal wherein a bookmark can be set at a particular section of a webpage.

The present invention also provides a webpage bookmarking method for a mobile terminal wherein a bookmarked section of a webpage can be registered in the mobile terminal and displayed later in the same state at the time of registration.

In accordance with an embodiment of the present invention, there is provided a webpage bookmarking method for a mobile terminal, including: checking, during web browsing, whether a division bookmark setting request is issued and setting, if a division bookmark setting request is issued, a division bookmark associated with a specified section of a webpage in display.

In accordance with another embodiment of the present invention, there is provided a webpage display method for a mobile terminal, including checking, in response to use of a bookmark feature during web browsing, whether a division bookmark is set in a webpage and displaying, if a division bookmark is set in the webpage, a section of the webpage associated with the division bookmark.

In accordance with another embodiment of the present invention, there is provided a webpage bookmarking/display method for a mobile terminal, including checking, during web browsing, whether a division specifying request is issued; and creating, if a division specifying request is issued, a mapping between a shortcut key and a specified section of a webpage.

### BRIEF DESCRIPTION OF THE DRAWINGS

The above features and advantages of the present invention will be more apparent from the following detailed description in conjunction with the accompanying drawings, in which:

FIG. 1 illustrates a communication environment for the present invention;

FIG. 2 illustrates a configuration of a mobile terminal for the present invention;

FIGS. 3A to 3C are flows charts illustrating a bookmarking method according to an exemplary embodiment of the present invention;

FIGS. 4A to 4C are screen representations for the bookmarking method of FIGS. 3A to 3C;

FIGS. 5A to 5D are screen representations for the bookmarking method of FIGS. 3A to 3C;

FIGS. 6A and 6B are screen representations for the bookmarking method of FIGS. 3A to 3C;

FIGS. 7A and 7B are flows charts illustrating a bookmarking method according to another exemplary embodiment of the present invention; and

FIGS. 8A to 8F are screen representations for the bookmarking method of FIGS. 7A and 7B.

### DETAILED DESCRIPTION OF THE INVENTION

Exemplary embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail.

The term ‘bookmark’ refers to a stored uniform resource locator (URL) of a webpage. Once a user sets a bookmark at a visited webpage, the user does not have to enter the address or URL of the webpage when revisiting the webpage at later times. In the present invention, a bookmark can be set at a particular division or section of a webpage. A bookmark is set at a selected section of a webpage by registering an identifier of the section, coordinates of the section, or a saved source of the section. Hence, a bookmark may be associated with a webpage or with a section of a webpage.

A division identifier (division ID) such as a ‘div’ tag in HyperText Markup Language (HTML) defines a division or section within a webpage. A webpage in the form of a ‘source’ or ‘source code’ is transmitted from a web server to a mobile terminal, which then renders the webpage into an on-screen page for viewing.

In the description, the mobile terminal is a terminal for user convenience, and may be any information and communication appliance or multimedia appliance, such as a mobile communication terminal, mobile phone, wired phone, wireless phone, portable multimedia player (PMP), personal digital assistant (PDA), smart phone, audio player, MPEG-1 Audio Layer 3 (MP3) player, notebook, or personal computer.

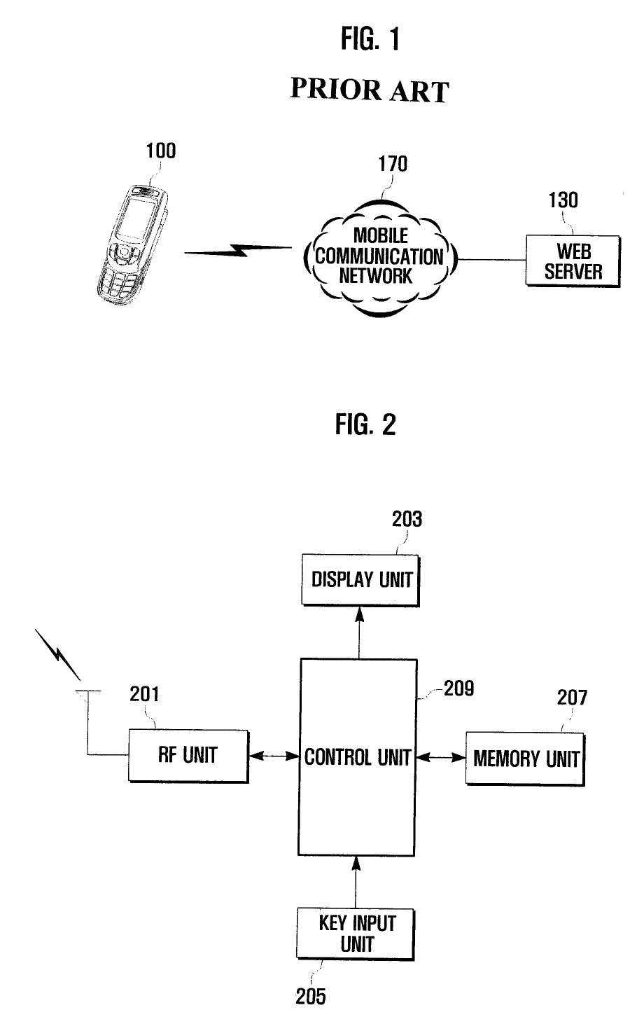

FIG. 1 illustrates a communication environment for the present invention. Referring to FIG. 1, a mobile terminal 100 communicates with a web server 130 through a mobile communication network 170.

The mobile terminal 100 provides a voice call service, short message service (SMS), and multimedia message service (MMS) with the help of the mobile communication network 170. The mobile terminal 100 may include a camera module for photographing a target object, and an MP3 module for playing a requested music file.

In particular, the mobile terminal 100 sends a request for a desired webpage through the mobile communication network 170 to the web server 130, and displays a webpage received from the web server 130 received in response to the request. When a division bookmark setting request is issued by the user during display of a webpage, the mobile terminal 100 sets a division bookmark at a specified section of the webpage. The specified section can be identified by a division identifier or coordinate values of the section in the webpage. A division identifier of the specified section can be obtained through parsing of the corresponding source. A division bookmark can be registered in a bookmark list using a division identifier or coordinate values.

In loading of a webpage in response to selection of a bookmark, if the webpage includes a bookmarked section, the mobile terminal 100 displays the bookmarked section rather than the beginning of the webpage.

The web server 130 receives a request for a webpage from the mobile terminal 100, and sends the requested webpage as a response to the mobile terminal 100.

FIG. 2 illustrates a configuration of the mobile terminal 100 for the present invention.

Referring to FIG. 2, the mobile terminal 100 includes a radio frequency (RF) unit 201, display unit 203, key input unit 205, memory unit 207, and control unit 209.

The RF unit 201 performs operations related to wireless communication for the mobile terminal 100. The RF unit 201 includes an RF transmitter for upconverting and amplifying the signal to be transmitted, and an RF receiver for low-noise amplifying a received signal and downconverting the frequency of the signal.

The RF unit 201 connects to the web server 130 to receive a webpage. That is, through the RF unit 201a request for a webpage is sent through the mobile communication network 170 to the web server 130, and in response to the request, downloads the requested webpage from the web server 130.

In particular, when a division bookmark registered through location information is selected, the RF unit 201 downloads the corresponding webpage for display.

The display unit 203 displays output data under the control of the control unit 209. In particular, the display unit 203 displays a selected webpage. When a division bookmark setting request is issued during display of a webpage, the display unit 203 displays a section of the webpage selected for bookmarking. When a webpage including a bookmarked section is accessed by the control unit 209, the display unit 203 displays the bookmarked section of the webpage.

The key input unit 205 generates a key signal according to user actions for controlling operations of the mobile terminal 100, and sends the key signal to the control unit 209. In particular, the key input unit 205 generates key signals for operations related to loading and displaying a webpage, setting of a division bookmark, and selecting a section for bookmarking.

The memory unit 207 may include a program memory section and data memory section. In particular, the memory unit 207 stores bookmark-related information. That is, the memory unit 207 stores a division bookmark and associated location data. The location data of a division bookmark can be location information such as a division identifier or coordinate values of the webpage section selected for bookmarking, or a saved source of the section.

The control unit 209 controls the overall operation of the mobile terminal 100. In particular, the control unit 209 controls the display of a webpage. When a division bookmark setting request is issued during display of a webpage, the control unit 209 sets a division bookmark at a selected section of the webpage, and registers the division bookmark and associated location data. The location data can be location information of the selected section or a saved source of the selected section.

The location information can be a division identifier of the selected section or coordinate values of the section. Coordinate values are registered only if the selected section does not have a division identifier. That is, if a section selected for bookmarking has a division identifier, the division identifier is registered. Otherwise, coordinate values of the selected section are registered.

At a later web session after registration, when a division bookmark registered through location information is selected, the control unit 209 downloads the up-to-date webpage and displays the bookmarked section of the downloaded webpage. When a division bookmark registered through saving is determined, the saved source of the corresponding section is displayed. That is, when a section of a webpage is bookmarked and registered through saving, the section is displayed later in the same state at the time of saving.

As described above, when a division bookmark setting request is issued through the key input unit 205 during display of a webpage, the control unit 209 controls the display unit 203 to display a section of the webpage selected by the user for bookmarking. As part of setting of a division bookmark at the selected section, the control unit 209 stores the division bookmark and associated location data in the memory unit 207 for registration. The location data may be location information such as a division identifier or coordinate values, or a saved source of the section. At a later web session, when the division bookmark is selected by the user, the corresponding section is displayed on the display unit 203 with saved or up-to-date content depending upon the manner of registration of the associated location data in the memory unit 207.

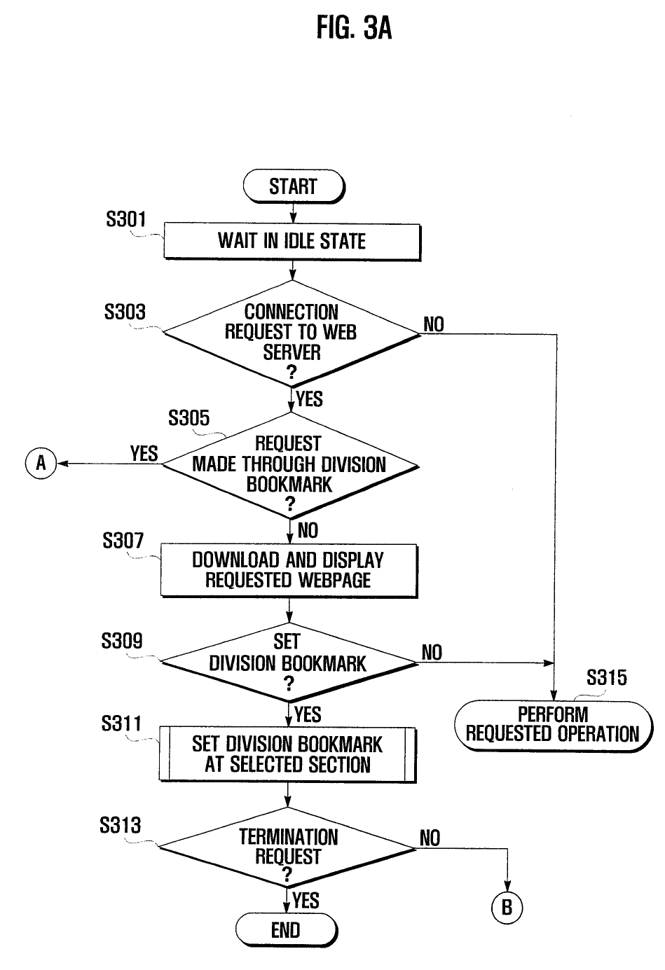

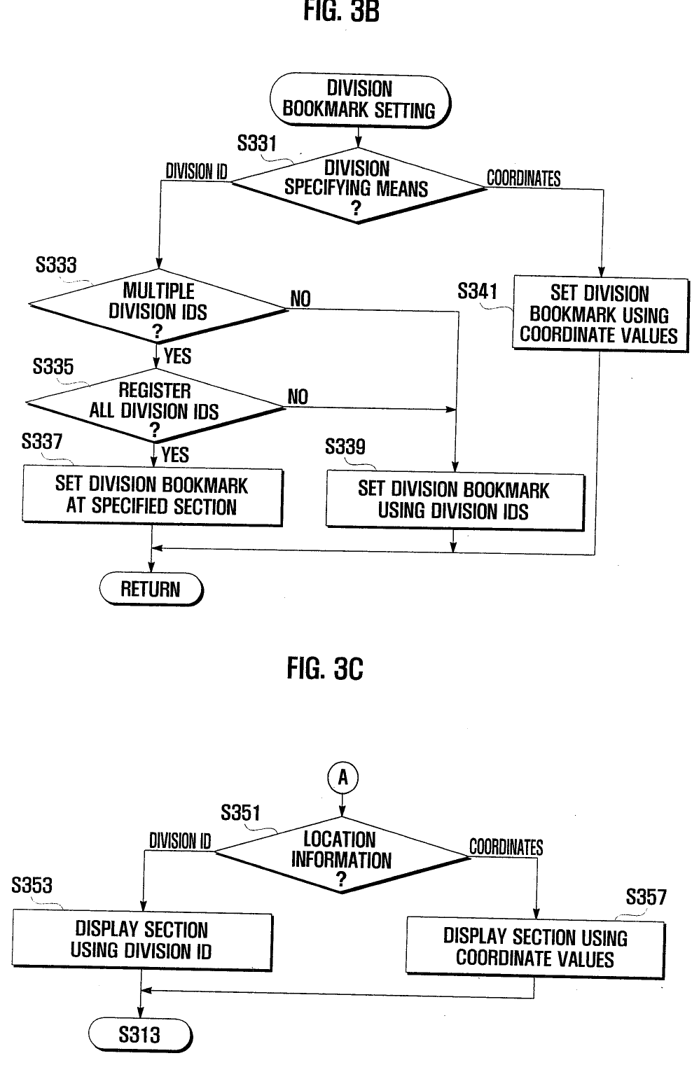

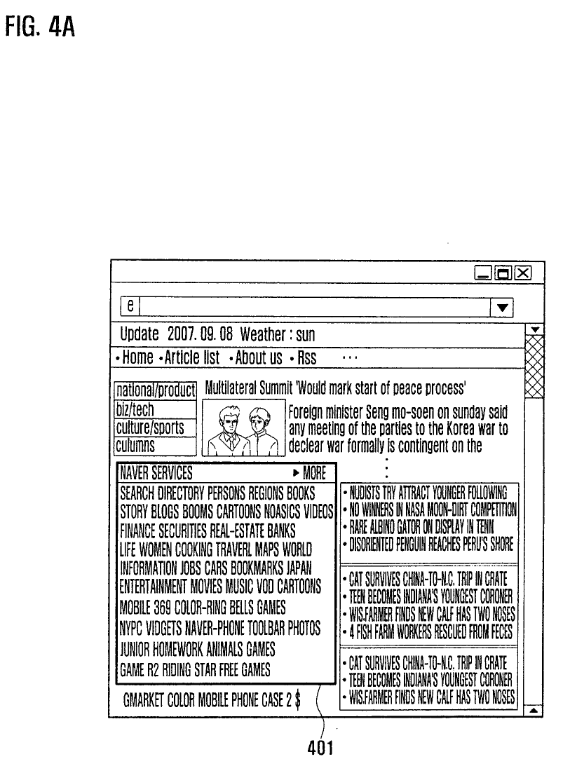

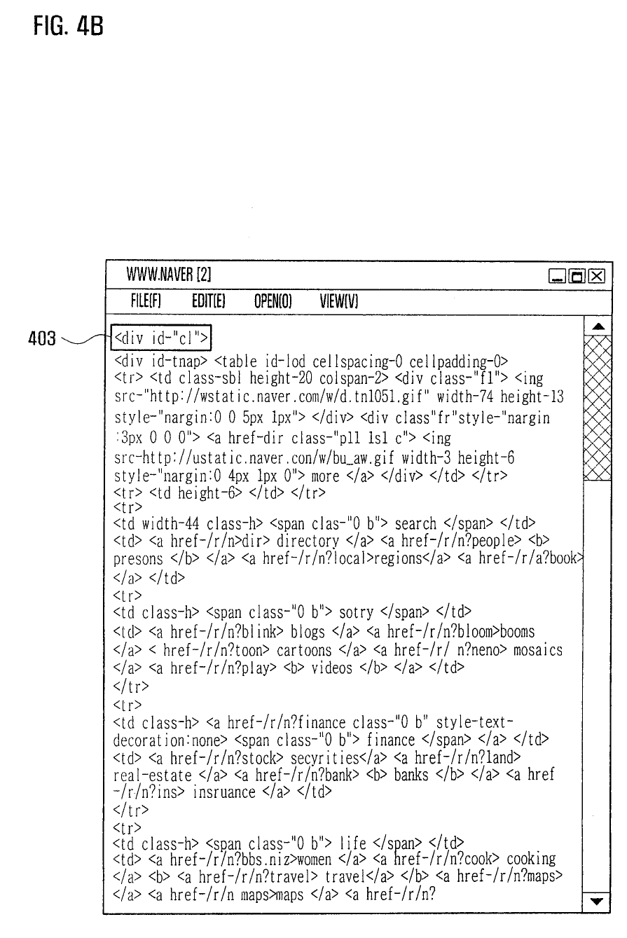

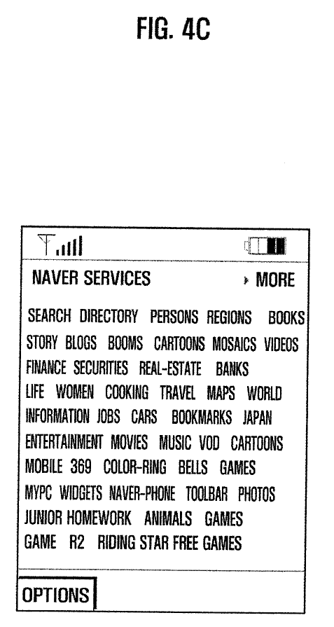

FIGS. 3A to 3C are flows charts illustrating a bookmarking method according to an exemplary embodiment of the present invention. FIGS. 4A to 4C, 5A to 5D, and 6A and 6B are screen representations for illustrating the bookmarking method. Referring to FIGS. 1 to 6B, the bookmarking method is described as follows.

Referring to FIG. 3A, the control unit 209 of the mobile terminal 100 waits for an event in an idle state (S301). The control unit 209 determines whether a request of connection to the web server 130 is issued by the user (S303). If a request of connection to the web server 130 is issued, the control unit 209 determines whether the connection request is made through selection of a division bookmark (S305). If the connection request is made by a URL directly entered through the key input unit 205, the control unit 209 connects to the web server 130, and downloads the webpage identified by the URL and displays the downloaded webpage on the display unit 203 (S307).

The control unit 209 determines whether a division bookmark setting request is issued (S309). The user can request to set a division bookmark at a particular section of a webpage in display by, for example, selecting an ‘options’ menu.

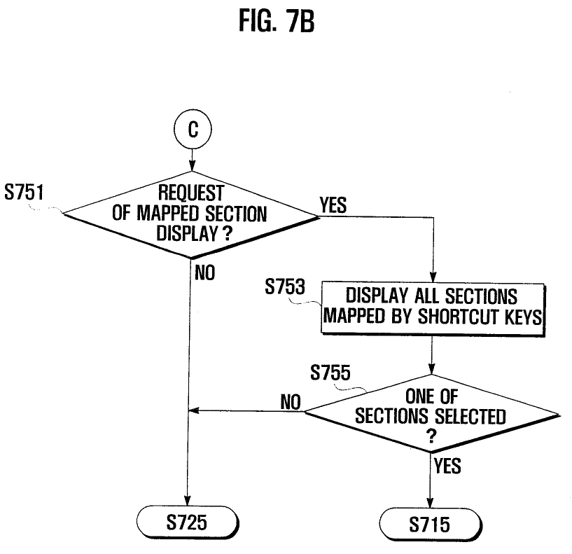

If a division bookmark setting request is issued, the control unit 209 sets a division bookmark at a selected section of the webpage (S311). Step S311 is further described in connection with FIG. 3B. The control unit 209 determines whether a request of connection termination is issued (S313). If a request of connection termination is issued, the control unit 209 terminates the connection to the web server 130. If a request of connection termination is not issued, subsequent operations are described in connection with FIG. 7A.

Referring to FIG. 3B, according to a division bookmark setting request, the control unit 209 requests the user to specify a section of the webpage being displayed, and checks the division specifying means used by the user (S331). A section can be specified using a division identifier or coordinate values. Other division specifying means may also be used.

If the division specifying means is a division identifier, the control unit 209 determines whether multiple division identifiers are present in the specified section (S333).

If a single division identifier is present in the specified section, the control unit 209 registers the division identifier as associated location data (S339).

For example, as illustrated in FIG. 4A, a webpage downloaded from the web server 130 includes a section 401 specified by the user for bookmarking. In FIG. 4B, a division identifier 403 corresponds to the specified section 401, which is displayed in FIG. 4C.

At step S339, the control unit 209 can register, as the location data, a division identifier or a saved source of the specified section according to user selection.

If multiple division identifiers are present in the specified section (S333), the control unit 209 requests the user to select at least one of the division identifiers (S335), and registers the selected division identifier (S339).

If the user selects all of the division identifiers, the control unit 209 registers all the division identifiers in the specified section (S337).

At steps S337 and S339, the control unit 209 can register the saved source corresponding to the specified section instead of a division identifier.

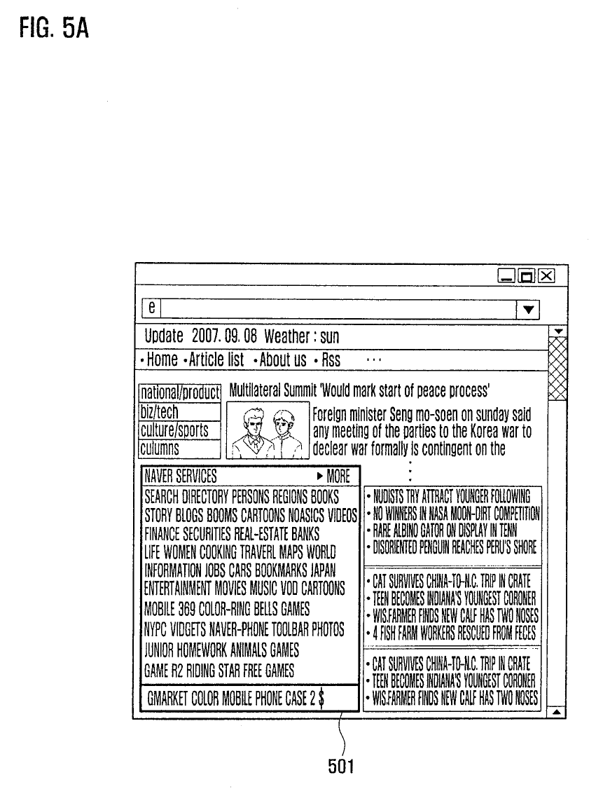

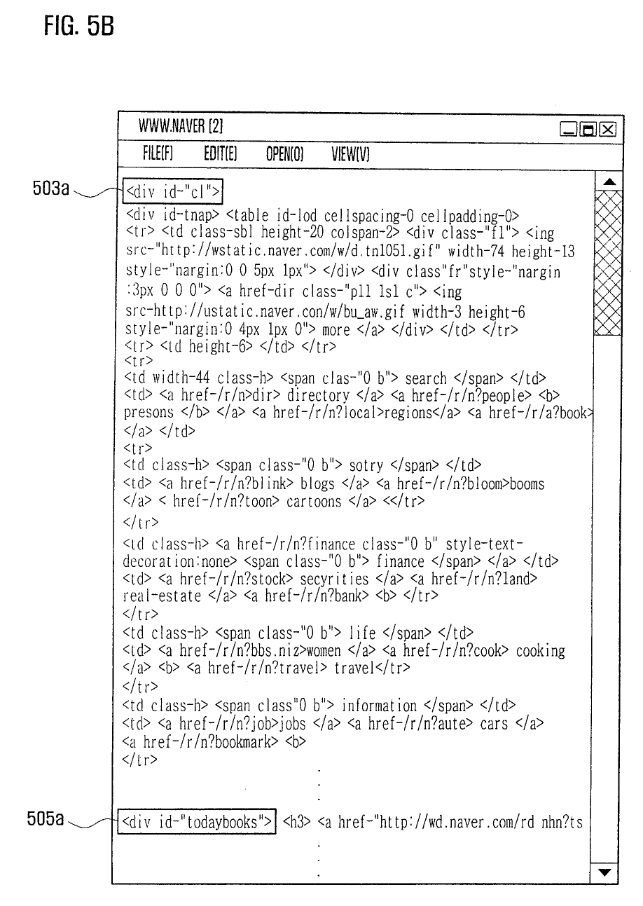

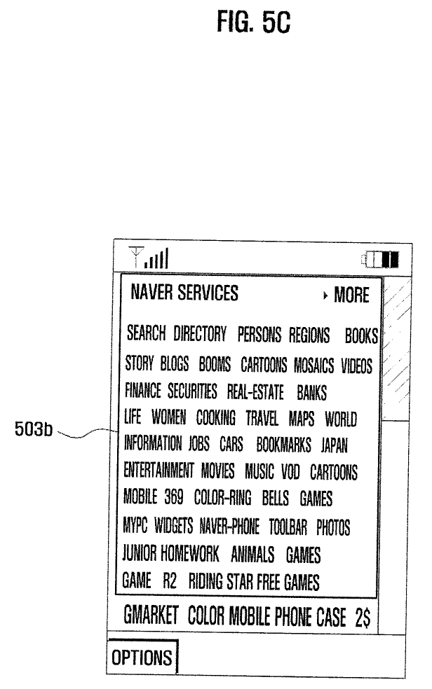

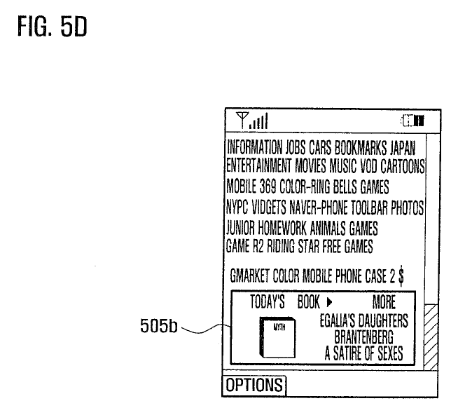

For example, in FIG. 5A, a specified section 501 includes two division identifiers 503a and 505a as shown in FIG. 5B. The division identifier 503a corresponds to a division 503b displayed in FIG. 5C, and the division identifier 505a corresponds to a division 505b displayed in FIG. 5D. The control unit 209 can register either the division identifiers 503a and 505a or the saved source corresponding to the specified section 501. If a specified section includes multiple division identifiers, the control unit 209 may display divisions corresponding to the division identifiers on the display unit 203 using a screen-scroll feature.

Returning to FIG. 3B, if the division specifying means is coordinates at step S331, the control unit 209 registers coordinate values of the specified section (S341). The control unit 209 can register the saved source corresponding to the specified section instead of coordinate values.

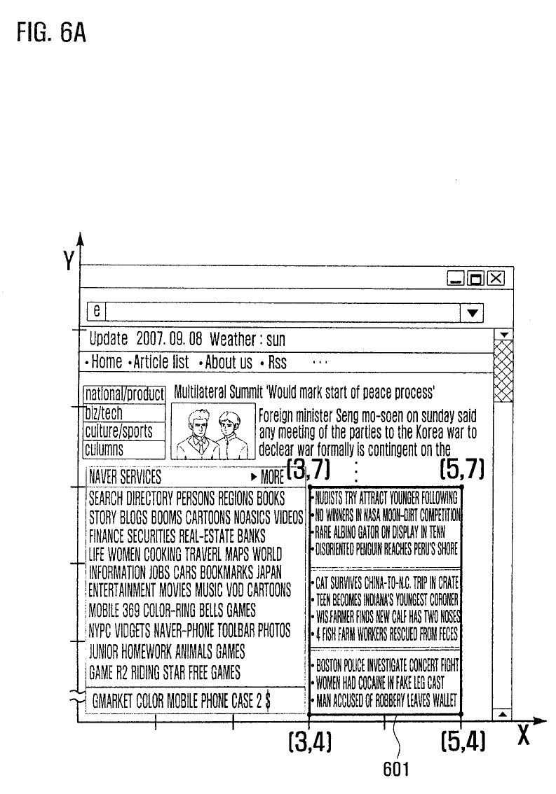

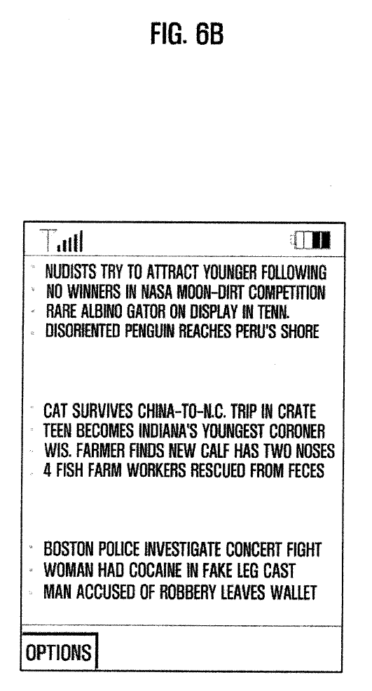

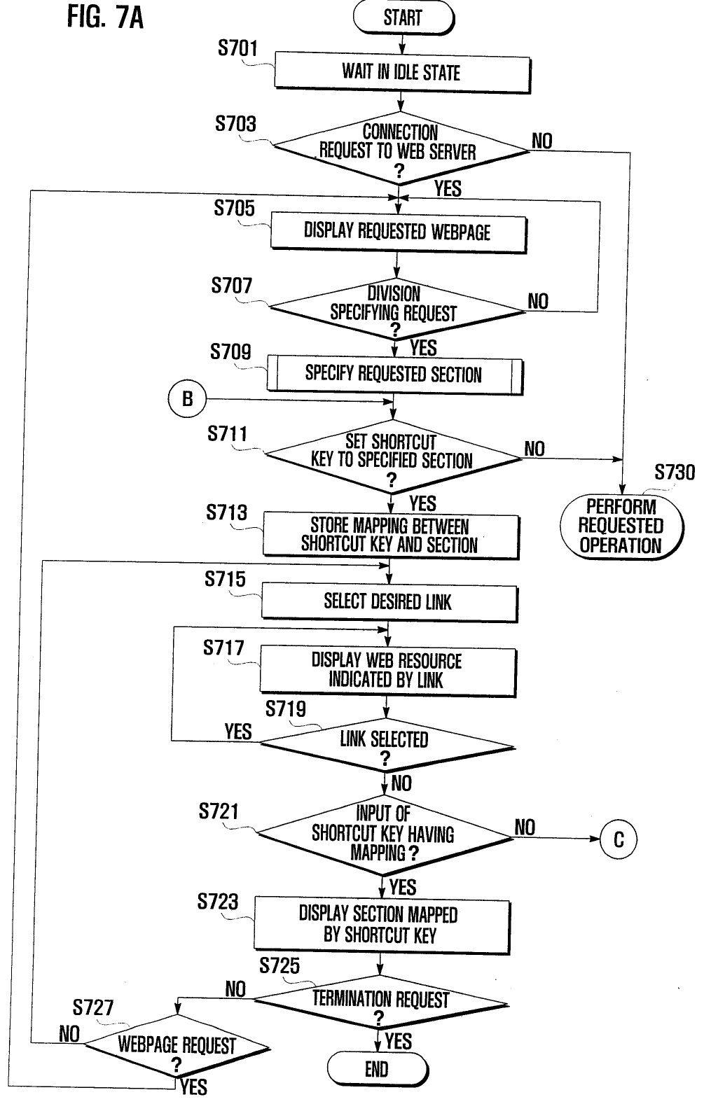

For example, as illustrated in FIG. 6A, a webpage downloaded from the web server 130 includes a section 601 specified by the user for bookmarking. The control unit 209 detects coordinate values of the specified section 601 within the webpage. The coordinate values may be given by points (3, 4), (5, 4), (3,7), and (5, 7), for example. The control unit 209 can register the coordinate values or saved source corresponding to the specified section 601 displayed in FIG. 6B.

If the request for connection to the web server 130 is made through selection of a division bookmark at step S305, referring to FIG. 3C, the control unit 209 checks registered location information associated the division bookmark (S351).

If the registered location information is a division identifier, the control unit 209 downloads that section of the webpage identified by the division bookmark and displays the specified section of the webpage using the registered division identifier on the display unit 203 (S353). That is, the up-to-date content of the specified section is delivered to the user. At step S353, the control unit 209 may display a specified section as in FIG. 4C, or FIGS. 5C and 5D for multiple division identifiers. After display of the section, the control unit 209 returns to step S313 in FIG. 3A.

If the registered location information is coordinates, the control unit 209 downloads that section of the webpage identified by the division bookmark and displays the specified section of the webpage corresponding to the registered coordinate values on the display unit 203 (S357). At step S357, the control unit 209 may display a specified section as in FIG. 6B. After display of the section, the control unit 209 returns to step S313 in FIG. 3A.

In particular, if the registered location data is a saved source, the control unit 209 displays the saved source of the specified section. That is, the content at the time of saving is delivered to the user.

As described above, the bookmarking method of the present embodiment enables the user to set a division bookmark at a desired section in a large webpage and to make a jump to the section later.

Hereinafter, a bookmarking method according to another embodiment of the present invention is described.

The bookmarking method of the present embodiment is similar to that of FIGS. 3A and 3B except that a shortcut key is mapped to a particular section of a webpage for easy viewing of the section.

The user can create a mapping between a shortcut key and a specified section of a webpage. The user stores a mapping between a shortcut key and a section of a webpage by registering a division identifier or coordinate values of the section, or a saved source of the section. A section of a webpage may include a link to a web resource. When the user selects the link, the web resource indicated by the link is downloaded from a web server if necessary and displayed.

Referring to FIG. 2, when the user selects a link in a displayed section, the RF unit 201 receives a web resource indicated by the link from the web server 130. When the user inputs a shortcut key that is mapped to a section registered through a division identifier or coordinate values, the RF unit 201 downloads a webpage containing the section from the web server 130. In response to a request of a webpage, the RF unit 201 receives the requested webpage from the web server 130.

The display unit 203 displays, in response to selection of a link in a displayed section, a web resource indicated by the link. The display unit 203 displays, in response to input of a shortcut key mapped to a section of a webpage, the section mapped by the shortcut key. If a request of mapped section display is issued, the display unit 203 displays all sections mapped by shortcut keys using mappings stored in the memory unit 207.

The key input unit 205 generates key signals related to a division specifying request, shortcut setting request, link selection, and request of mapped section display.

The memory unit 207 stores a mapping between a shortcut key and a specified section of a webpage according to a shortcut setting request. The mapping can be stored in the memory unit 207 as a pair of a key value and location data of the mapped section. The location data may be a division identifier or coordinate values of the section, or a saved source of the section.

The control unit 209 specifies a section of a webpage for display in response to a division specifying request, and creates a mapping between a shortcut key and the specified section according to a shortcut setting request. Number keys of the key input unit 205 can be used as shortcut keys. The control unit 209 stores the created mapping in the memory unit 207.

When the user selects a link in a section of a web page, the control unit 209 jumps to a web resource indicated by the link and causes the display of the selection section. When the user inputs a shortcut key mapped to a section, the control unit 209 displays the mapped section using a mapping stored in the memory unit 207. If a request of mapped section display is issued, the control unit 209 displays all sections mapped by individual shortcut keys using mappings stored in the memory unit 207.

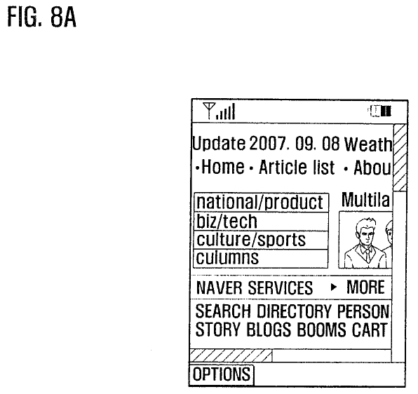

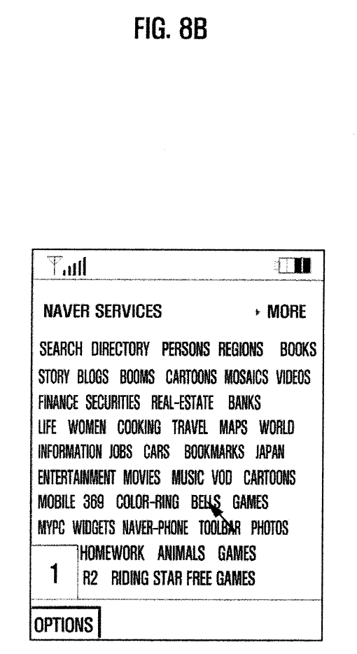

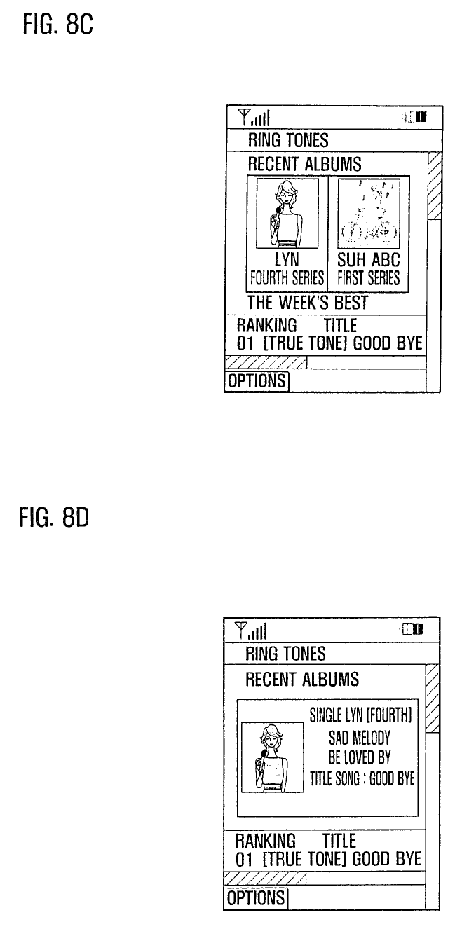

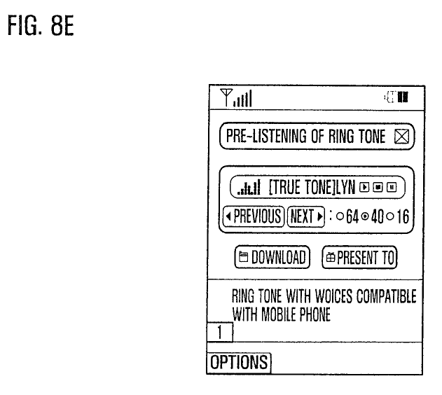

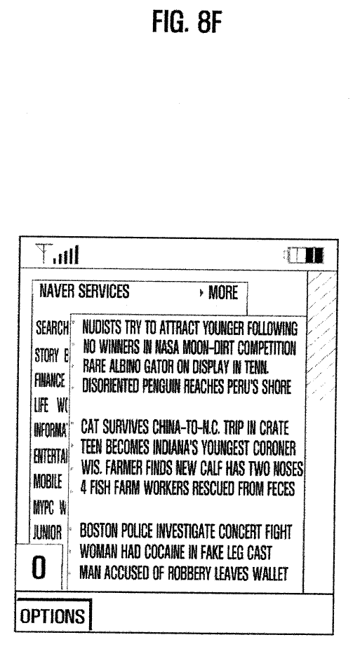

FIGS. 7A and 7B are flows charts illustrating the bookmarking method of the present embodiment. FIGS. 8A to 8F are screen representations for the bookmarking method. Referring to FIGS. 1, 2, 7A, 7B, and 8A to 8F, the bookmarking method is described as follows.

Referring to FIG. 7A, the control unit 209 of the mobile terminal 100 waits for an event in an idle state (S701). The control unit 209 determines whether a request of connection to the web server 130 is issued by the user (S703). If a request of connection to the web server 130 is issued, the control unit 209 connects to the web server 130, downloads a webpage identified by a URL entered through the key input unit 205, displays the downloaded webpage on the display unit 203 (S705). For example, as illustrated in FIG. 8A, a requested webpage is displayed on the display unit 203 in an adjusted size for the screen.

The control unit 209 determines whether a division specifying request is issued (S707). The user can specify a section of the webpage in view by, for example, selecting an ‘options’ menu. If a division specifying request is not issued, the control unit 209 continues to display the webpage.

If a division specifying request is issued, the control unit 209 specifies a section of the webpage (S709). The section specifying operation is performed in the same manner described in connection with FIGS. 3A and 3B. For example, a section specified by the user is illustrated in FIG. 8B. A section of a webpage can be specified using a division identifier or coordinate values.

The control unit 209 determines whether a shortcut setting request is issued (S711). Step S711 can also be performed for bookmarking (step S313 in FIG. 3A).

If a shortcut setting request is issued, the control unit 209 creates a mapping between a shortcut key and the specified section, and stores the created mapping (S713). For example, FIG. 8B illustrates a mapping between the shortcut key ‘1’ to a specified section. Information on the section can be stored as a division identifier or coordinate values, or a corresponding source.

When the user selects a link in the displayed section (S715), the control unit 209 displays a web resource indicated by the link (such as a webpage, section of a webpage, or image file) (S717). For example, in FIG. 8B, selection of a link ‘bell’ causes display of a section indicated by the link ‘bell’, as in FIG. 8C.

Whenever the user selects a link in the displayed section (S719), the control unit 209 displays a web resource indicated by the link. For example, in FIG. 8C, when a link to an album of an artist is selected, a section related to the album is displayed as in FIG. 8D. When a link to a song is selected in FIG. 8D, a section related to pre-listening of the song is displayed as in FIG. 8E.

The control unit 209 checks whether a shortcut key mapped to a section is input (S721). If a shortcut key mapped to a section is input, the control unit 209 displays the mapped section of a webpage (S723). For example, when the shortcut key ‘1’ is input during display of a section of one of FIGS. 8C to 8E, the section of FIG. 8B is displayed.

The control unit 209 determines whether a request of connection termination is issued (S725). If a request of connection termination is issued, the control unit 209 terminates the connection to the web server 130. If a request of connection termination is not issued, the control unit 209 determines whether a webpage request is issued (S727). If a webpage request is issued, the control unit 209 returns to step S705 for further webpage display. If a webpage request is not issued, the control unit 209 returns to step S715. If a shortcut key mapped to a section is not input at step S721, referring to FIG. 7B, the control unit 209 checks whether a request of mapped section display is issued (S751). If a request of mapped section display is not issued, the control unit 209 returns to step S725.

If a request for a mapped section display is issued, the control unit 209 displays all sections mapped by individual shortcut keys using mappings stored in the memory unit 207 (S753). For example, as illustrated in FIG. 8F, when a request of mapped section display is issued through the shortcut key ‘0’, the control unit 209 displays a plurality of sections mapped by shortcut keys.

At step S753, for a mapped section whose stored location data is a division identifier or coordinates, the control unit 209 receives an up-to-date webpage containing the mapped section from the web server 130, if necessary, and then displays the section. For a mapped section whose stored location data is a saved source, the control unit 209 displays the stored source of the section.

Thereafter, the control unit 209 determines whether one of the displayed sections is selected (S755). If one of the displayed sections is selected, the control unit 209 displays the selected section in full screen mode and returns to step S715. If one of the displayed sections is not selected, the control unit 209 returns to step S725.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

As apparent from the above description, the present invention provides a webpage bookmarking method for a mobile terminal wherein a bookmark can be set at a desired section of a webpage, thereby enabling a direct jump to the bookmarked section for viewing.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A webpage bookmarking method for a mobile terminal, comprising the steps of:
checking, during web browsing, whether a division bookmark setting request is issued; and
setting, if a division bookmark setting request is issued, a division bookmark at a specified section of a webpage in display.

2. The webpage bookmarking method of claim 1, wherein the step of setting a division bookmark comprises the step of:
registering, if the section is specified using a division identifier, the division identifier of the specified section.

3. The webpage bookmarking method of claim 2, wherein the step of setting a division bookmark further comprises the step of:
checking whether the specified section contains a plurality of division identifiers;
requesting, if the specified section contains a plurality of division identifiers, a user to select at least one of the division identifiers; and
registering the selected division identifier.

4. The webpage bookmarking method of claim 3, wherein the step of setting a division bookmark comprises the step of:
registering a saved source corresponding to the specified section specified using a division identifier.

5. The webpage bookmarking method of claim 1, wherein the step of setting a division bookmark comprises the step of:
registering, if the section is specified using coordinates, coordinate values of the specified section.

6. The webpage bookmarking method of claim 5, wherein the coordinate values are defined within the webpage being displayed.

7. The webpage bookmarking method of claim 6, wherein the step of setting a division bookmark comprises the steps of:
registering a saved source of the section specified using the defined coordinates.

8. The webpage bookmarking method of claim 1, further comprising the step of:
creating a mapping between a shortcut key and a bookmarked section of the webpage.

9. The webpage bookmarking method of claim 8, wherein the step of creating a mapping comprises the step of:
registering, if the bookmarked section is specified using a division identifier, the division identifier of the bookmarked section and
registering, if the bookmarked section is specified using coordinate values, the coordinate values of the bookmarked section.

10. The webpage bookmarking method of claim 9, further comprising the steps of:
checking whether a link in a displayed section is selected; and
displaying a web resource indicated by the selected link.

11. The webpage bookmarking method of claim 10, further comprising the step of:
checking whether a shortcut key mapped to a bookmarked section of a webpage being displayed is input; and
displaying the bookmarked section mapped by the input shortcut key.

12. The webpage bookmarking method of claim 11, further comprising the step of:
checking whether a request of mapped section display is issued;
displaying all sections mapped by individual shortcut keys; and
displaying, upon selection of one of the mapped sections, the selected section in full screen mode.

13. A webpage display method for a mobile terminal, comprising the step of:
checking, in response to use of a bookmark feature during web browsing, whether a division bookmark is set in a webpage in display; and
displaying a section of the webpage corresponding to the bookmark indicated by the division bookmark.

14. The webpage display method of claim 13, wherein the step of displaying a bookmarked section comprises the steps of:
downloading, if the division bookmark is registered using a division identifier, the webpage.

15. The webpage display method of claim 13, wherein the step of displaying a bookmarked section comprises the step of:
downloading, if the division bookmark is registered using coordinate values, the webpage.

16. The webpage display method of claim 13, further comprising the step of:
creating, according to a shortcut setting request, a mapping between a shortcut key and the displayed section.

17. The webpage display method of claim 16, wherein the step of creating a mapping comprises the step of:
registering if the division bookmark is specified using a division identifier, the division identifier of the bookmarked section and
registering, if the division bookmark is registered using coordinate values the coordinate values of the bookmarked section.

18. The webpage display method of claim 17, further comprising the step of:
checking whether a link in a section in display is selected; and
displaying a web resource indicated by the selected link.

19. The webpage display method of claim 18, further comprising the step of:
checking whether a shortcut key mapped to a section of a webpage is input; and
displaying the section mapped by the input shortcut key.

20. The webpage display method of claim 19, further comprising the step of:
checking whether a request of mapped section display is issued;
displaying all sections mapped by individual shortcut keys; and
displaying, upon selection of one of the mapped sections, the selected section in full screen mode.

21. A webpage bookmarking/display method for a mobile terminal, comprising the steps of:
checking, during web browsing, whether a division specifying request is issued; and
creating, if a division specifying request is issued, a mapping between a shortcut key and a specified section of a webpage in display.

22. The webpage bookmarking/display method of claim 21, wherein the step of creating a mapping comprises the step of:
registering at least one of the division identifier of the specified section and the coordinate values of the specified section.

23. The webpage bookmarking/display method of claim 22, further comprising the steps of:
checking whether a link in a section in display is selected;
displaying a web resource indicated by the selected link; and
displaying, when a shortcut key mapped to a section is input, the section mapped by the input shortcut key.

24. The webpage bookmarking/display method of claim 23, further comprising the steps of:
checking, in response to a request of displaying a new webpage, whether a division specifying request is issued.

25. The webpage bookmarking/display method of claim 24, further comprising the steps of:
checking whether a request of mapped section display is issued;
displaying all sections mapped by individual shortcut keys; and
displaying, upon selection of one of the mapped sections, the selected section in full screen.
